(19) United States
(12) Patent Application Publication
(10) Pub. No.: US 2003/0119536 A1
(43) Pub. Date: Jun. 26, 2003

(54) Arbitrated audio communication with reduced latency

(76) Inventor: James A. Hutchison, San Diego, CA (US)

Correspondence Address: QUALCOMM Incorporated, Attn: Patent Department, 5775 Morehouse Drive, San Diego, CA, 92121-1714, US

(21) Appl. No.: 10/034,776

(22) Filed: Dec. 21, 2001

(51) Int. Cl. H04Q 7/20

(52) U.S. Cl. 455/517; 455/518; 455/519

(57) ABSTRACT

An arbitrated communication system provides reduced audio latency by transmitting audio with transmission of an access request. To obtain access to a broadcast link, a request for access is transmitted to an arbitration controller. The user does not wait for an indication that the access request has been granted. Instead, the audio is transmitted following or integrated with transmission of the request. If the request is denied, the audio is discarded. In most instances, however, the request will be granted. As a result, the audio can be transmitted relatively immediately, significantly reducing latency in the system.

### FIELD

This disclosure relates generally to communication systems and, more particularly, to point-to-multipoint communication systems that provide arbitrated audio communication among multiple participants.

### BACKGROUND

A point-to-multipoint communication system provides audio communication among two or more users of the system. The communication for a call is arbitrated among the participants to allow one user at a time to send communications to the others. One example of a point-to-multipoint communication system is a push-to-talk system in which participants communicate with one another as a group using wireless and/or wired communication devices. Typically, a push-to-talk system relies on a shared communication link, sometimes called a broadcast link or multi-cast link, over which audio communications are received simultaneously by multiple communication devices. A broadcast link can also be implemented by combining several communication links together. Typically, only one participant can transmit information to the other participants at a given time. However, all group participants can listen to the speaker via the broadcast link.

A participant who desires to communicate with the other participants typically presses a talk button on a communication device. In response, the communication device transmits a request for access to an arbitration controller. An arbitration controller, which may be integrated with wireless network equipment in the system, limits access to the broadcast link to only one participant at a given time. The arbitration controller processes the request and replies with an indication that access is either granted or denied. Once access is granted, the requesting participant has sole access to the broadcast link for transmission of audio communications to the other participants. In this case, the requesting participant may begin to speak, and the communication device begins to transmit the audio communication. When more than one participant desires to speak, the arbitration controller arbitrates access to the broadcast link among the participants.

### SUMMARY

This disclosure is directed to an arbitrated audio communication system and method for point-to-multipoint communication with reduced latency.

In one embodiment, a method comprises transmitting a request for access to a broadcast link in a point-to-multipoint communication system, transmitting audio with the access request, and terminating the audio transmission in the event the access request is denied. Computer-readable media for implementing such a method are also described.

In another embodiment, a method comprises receiving a request for access to a broadcast link in a point-to-multipoint communication system, receiving audio with the access request, and transmitting the audio via the broadcast link in the event the access request is granted. Computer-readable media for implementing such a method are also described.

In a further embodiment, a wireless communication device comprises a wireless transmitter, and a processor that controls the transmitter to transmit a request for access to a broadcast link in a point-to-multipoint communication system, transmit audio with the access request, and terminate the audio transmission in the event the access request is denied.

In an added embodiment, an arbitration controller for a point-to-multipoint communication system comprises a processor that receives a request for access to a broadcast link from a wireless communication device in a point-to-multipoint communication system, wherein the wireless communication device transmits audio with the request for access, the processor determining whether to grant the access request, and directing transmission of the audio via the broadcast link in the event the access request is granted.

Additional details of these and other embodiments are set forth in the accompanying drawings and the description below. Other features will become apparent from the description and drawings, and from the claims.

### BRIEF DESCRIPTION OF DRAWINGS

FIG. 1 is a block diagram illustrating a point-to-multipoint wireless communication system.

FIG. 2 is a diagram illustrating an arbitration path.

FIG. 3 is a timing diagram illustrating a process for arbitration of audio communication in a wireless communication system.

FIG. 4 is a diagram illustrating an alternative arbitration path.

FIG. 5 is a block diagram illustrating the general structure of an example wireless communication device for use in the system of FIG. 1.

FIG. 6 is a block diagram illustrating the general structure of an example base station for use in the system of FIG. 1.

FIG. 7 is a flow diagram illustrating a process for arbitration of audio communication in a wireless communication system from the perspective of a device requesting access.

FIG. 8 is a flow diagram illustrating a process for arbitration of audio communication in a wireless communication system from the perspective of an arbitrating device.

FIG. 9 is a flow diagram illustrating a process for arbitration of audio communication from the perspective of another type of arbitrating device.

### DETAILED DESCRIPTION

This disclosure is directed to an arbitrated audio communication system and method for point-to-multipoint communication with reduced latency. To obtain access to the broadcast link, a user transmits a request for access and audio representing a desired audio communication to an arbitration controller. Thus, the user does not wait for an indication that the access request has been granted. Instead, the user transmits the audio relatively immediately.

The intelligence required for arbitration may be implemented in any of a variety of network equipment including, e.g., a base transceiver station (BTS), a base station controller (BSC), or a server handling voice-over-IP communications. In addition, arbitration may be implemented within communication devices such as a wireless communication device.

If the access request is denied, the audio is discarded. In most instances of typical polite conversation, however, the request will be granted. As a result, the audio can be transmitted immediately, significantly reducing latency in the system. Latency, i.e., a delay in the start of communication by a participant, can be disconcerting to participants attempting to conduct a conversation.

According to some embodiments, transmission of the audio may immediately follow the access request. In other embodiments, the access request may be integrated with the audio communication. In particular, detection of the audio itself may serve as the access request for an arbitration controller, eliminating the need for a separate request to be communicated.

Alternatively, detection of the audio by the speaker's wireless communication device may trigger transmission of an access request and the audio to the arbitration controller. In either case, by transmitting the audio immediately, excessive delay can be eliminated between the transmission of the access request and the transmission of the audio. Specifically, it is not necessary to wait for an acknowledgement that the access request has been granted before transmitting the audio communication.

By reducing audio latency, a system and method as described herein can promote quality of service among participants in a point-to-multipoint communication system. In particular, users can conduct conversations more readily without suffering the awkwardness of extended delays between audio received from different speakers. In addition, in some embodiments, arbitration can be accomplished without extensive network reconfiguration or hardware redeployment. For example, arbitration can be performed within wireless communication devices rather than in wireless network equipment, such as a BTS or BSC, enabling more flexible implementation of arbitration schemes via wireless communication devices without the need to make network-level changes. In many embodiments, however, it may be desirable to implement arbitration within the network equipment. If arbitration is implemented in the wireless communication devices, the arbitration processing responsibilities may migrate from device to device as each device is granted access to the broadcast in response to an access request. In other words, if arbitration is implemented in the wireless communication device, the device in control of the broadcast typically will be the device that processes access requests from other devices and sends either a denial or grant of each access request.

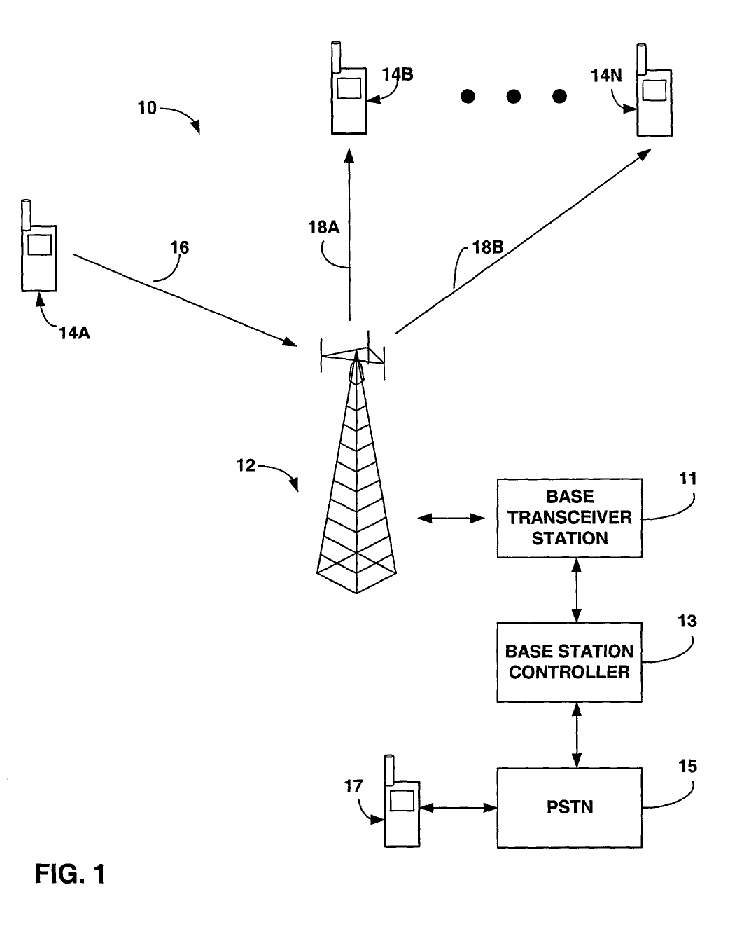

FIG. 1 is a block diagram illustrating a point-to-multipoint wireless communication system 10. A wireless base station 12 permits a number of wireless communication devices 14A-14N (hereinafter 14) to communicate with one another and with other devices on networks connected to system 10. As shown in FIG. 1, using wireless communication device 14A, a participant may send an outgoing communication 16. Participants associated with wireless communication devices 14B-14N receive the communication sent by wireless communication device 14A as incoming communications 18A, 18B, respectively.

Although three wireless communication devices 14 are shown in FIG. 1 for purposes of example, communication may take place between two or more participants. Exemplary wireless communication devices 14 may include cellular radiotelephones, PCMCIA cards incorporated within computers, personal digital assistants (PDAs) and personal computers equipped with wireless communication capabilities, and the like. System 10, including base station 12 and wireless communication devices 14, may conform to one or more wireless communication standards. Example wireless communication standards include CDMA, GSM, WCDMA, and the like.

Base station 12 also may provide an interface between wireless communication devices 14 and wired telephony systems such as a public switched telephone network (PSTN). In this manner, base station 12 may route calls between wireless communication devices 14 and other remote wireless network equipment or wired telephony equipment connected to PSTN 15. In either case, in response to a request from a user to initiate a call, base station 12 allocates a broadcast link to a group of users associated with wireless communication devices 14. Base station 12 may manage multi-point communications over a number of broadcast links simultaneously.

Thus, as further shown in FIG. 1, the group of participants may include participants communicating via wired communication devices. For example, base station 12 may include a base transceiver station (BTS) 11 that interacts with a base station controller (BSC) 13 and public switched telephone network (PSTN) 15 to facilitate communications with one or more wired telephones 17 or other wired telephony devices, e.g., computer telephony systems. In addition, in some embodiments, one or more of the wireless or wired communication devices may be equipped for one-way communication. In other words, some of the devices may be equipped to receive communication over the broadcast link, but not to send communications. Thus, some of the devices may serve as listen-only devices.

Upon initiation of a call, base station 12 or other network equipment functioning as the arbitration controller within system 10 thereafter handles arbitration of access to the broadcast link among the multiple users. Arbitration may involve a determination of priority of access based on any number or combination of arbitration schemes. The arbitration schemes may be based on, for example, the relative timing of access requests made by different users, direction of a user, a hierarchy of predetermined priorities assigned to particular users, round robin techniques, token passing techniques, temporal leasing techniques, and the like. In general, the arbitration controller allocates the broadcast link for audio communication by a particular participant until the broadcast link is relinquished or priority is reassigned.

To reduce latency in conversations between participants, the arbitration controller, e.g., network equipment within base station 12 or elsewhere, may be configured to accept both access requests and accompanying audio in relatively quick succession. Conversely, each wireless communication device 14 may be configured to accompany an access request with the audio communication without waiting for the result of an arbitration decision by the arbitration controller. Instead of arbitrating an access request, sending a reply to the requesting participant, and then waiting for transmission of audio, base station 12 is able to receive the audio communication immediately. For example, wireless communication device 14 may transmit the audio communication immediately following the access request. Alternatively, the audio communication itself may form the access request.

The arbitration controller arbitrates among the access request, pending requests from other users, and the existing allocation, and either grants or denies the request. The audio sent with the access request may be temporarily buffered at base station 12 pending the outcome of the arbitration. If the access request is granted, the arbitration controller directs base station 12 to immediately send the accompanying audio communication over the broadcast link to the other wireless communication devices 14. The broadcast link is the allocated for additional audio communication from the requesting user. In addition, the arbitration controller may direct base station 12 to send an acknowledgment to the requesting participant to indicate that the access request has been granted. At this point, the participant continues to transmit the audio communication via the pertinent wireless communication device 14 until the audio communication is complete or another user is given priority over the broadcast.

If the access request is denied, the arbitration controller may direct base station 12 to discard the buffered audio. In some embodiments, as described below, arbitration may take place within a wireless communication device 14, rather than within the network equipment. In some embodiments, the arbitration controller may be located within a wide area network associated with base station 12. In particular, the arbitration controller may be implemented by a processor within a network server that interacts with base station 12 or other network equipment to process access requests. In this case, the network server receives an access request from a wireless communication device via base station 12, processes the request, and downloads a denial or grant of the request to the wireless communication device via the base station.

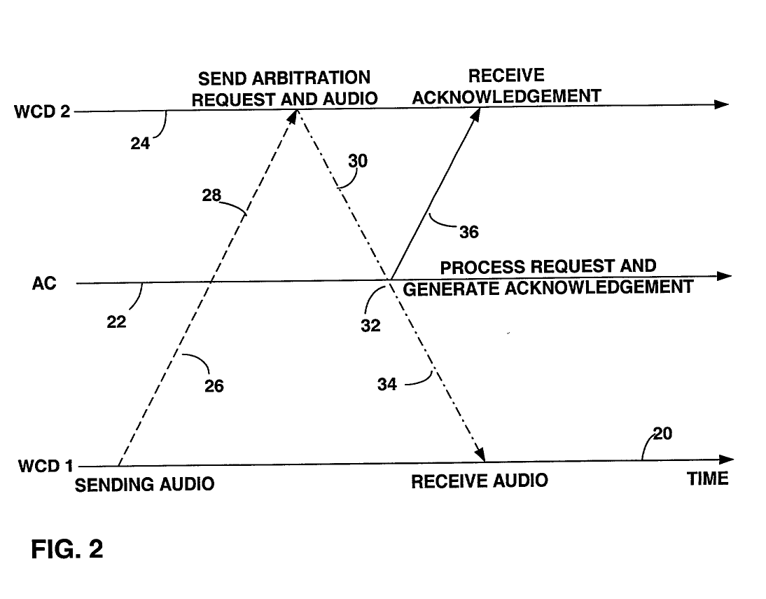

FIG. 2 is a diagram illustrating an arbitration path. In particular, FIG. 2 illustrates arbitration by base station 12 in response to a request for access to the broadcast link by a wireless communication device 14. In FIG. 2, line 20 indicates the perspective of a first wireless communication device (WCD 1), line 22 indicates the perspective of an arbitration controller (AC), and line 24 indicates the perspective of a second wireless communication device (WCD 2), which may be one of many wireless communication devices in system 10. Each of lines 20, 22, 24 represents the elapse of time from left to right as arbitration takes place within system 10. Again, the arbitration controller may be implemented within the BTS, BSC or other wireless network equipment (WNE) within system 10. In addition, in some embodiments, arbitration may take place within a server that handles voice-over-IP communications. Accordingly, the structure for realizing the functionality of the arbitration controller may vary.

Initially, WCD 1 has broadcast priority and is sending an audio communication (26) pursuant to a previous arbitration. The arbitration controller directs the audio over the broadcast link to one or more wireless communication devices, including WCD 2 (28). When WCD 2 desires access to the broadcast link, it sends not only an access request (30), but also the audio communication (30). The request and audio may be sent simultaneously or in rapid succession. In either case, WCD 14 does not wait for an acknowledgement from the arbitration controller. In the example of FIG. 2, the arbitration controller processes the request (32) and generates an acknowledgement.

If the request is granted, the arbitration controller directs the audio from WCD 2 over the broadcast link to other users, including WCD 1 (34). In addition, the arbitration controller may send an acknowledgement that the request has been granted to WCD 2 (36). Upon receipt of the acknowledgement that the request has been granted, the participant associated with WCD 2 may receive a notification, e.g., a visual, audible, or tactile indication, that the access request was successful. Consequently, the participant can be certain that the previous audio communication was successfully transmitted over the broadcast link, and may continue with transmission of the remainder of the audio communication.

In some cases, there may be a delay between an initial audio communication to obtain access to the broadcast link and additional audio communication sent following receipt of a favorable acknowledgment, i.e., an acknowledgement that the access request was granted. In most applications, however, it may be more desirable to have a seamless operation in which the participant simply continues speaking unless he receives an unfavorable acknowledgement.

In the event the access request is not granted, the arbitration controller sends an unfavorable acknowledgement to WCD 2, and the arbitration controller does not direct the audio from WCD 2 over the broadcast link to other users. In addition, the audio transmission received from WCD 2 is discarded. The arbitration controller directs the appropriate network equipment to allocate the broadcast link to another user or leave the broadcast link allocated to an existing user. The audio may be temporarily buffered by the network equipment, e.g., base station 12, while the arbitration of the access request is processed. Upon denial of the access request, the arbitration controller may direct that the buffered audio simply be purged.

In the case of an unfavorable acknowledgement, WCD 2 may generate an indication of the unfavorable acknowledgement, again as a visual, audible or tactile indication, to the user. In response, the participant simply stops speaking. In addition, WCD 2 may terminate audio transmission so that the participant's speech is not communicated to base station 12. To limit the rate of arbitration requests, WCD 2 may apply a time delay that prevents arbitration requests for a limited period following receipt of an unfavorable acknowledgement.

Notably, as shown in FIG. 2, sending the audio with the access request substantially reduces delay that can cause latency in receipt of the audio communication by other wireless communication devices. In some cases, the acknowledgement sent to the user requesting access may arrive while the audio communication sent by the user is being communicated to the other users over the broadcast link. The savings in time can amount to one to two full round-trip delays, plus other system latencies, depending on the arrangement of system 10.

For example, when arbitration is preformed within the network equipment, e.g., within the BTS or BSC, waiting for transmission of the request from WCD 2 to the network equipment (one half round-trip), and then waiting for a denial or grant of the request to be transmitted to WCD 2 from the network equipment (another half round-trip) would introduce a full round-trip delay. Reduced delays would be even more significant in the event system 10 is designed such that all or part of arbitration is carried out within wireless communication devices 14 rather than base station 12.

Performance of arbitration within a wireless communication device 14 may be generally desirable. In particular, arbitration schemes could be more readily implemented without the need for substantial changes to the network equipment, including base station 12. For example, wireless communication devices 14 could be updated, by firmware or otherwise, to handle arbitration within a particular wireless communication device forming part of a calling group.

The wireless communication device 14 responsible for arbitration could be the device that initiated a call to the group, or a device that presently holds priority over the broadcast link. In either case, a wireless communication device requesting access to the broadcast link must send the request to the device responsible for arbitration rather than base station 12, although the communication may pass through the network equipment.

When a wireless communication device 14 handles arbitration, the arbitration may require two full round-trips of delay prior to sending an audio communication. In particular, to transmit audio, the wireless communication device 14 requesting access must first wait for transmission of the request to the network equipment (one half round-trip), transmission of the request from the network equipment to the wireless communication device in charge of arbitration (a second half round-trip), transmission of an acknowledgment from the arbitrating device to the network equipment (one half round-trip) and, finally, transmission of the acknowledgment from the network equipment to the device that requested access. Thus, in this type of arrangement, the wireless communication device 14 may need to wait two entire round-trip delays before transmitting audio.

When the transmitted audio is a response to another user in the course of a conversation, the delay can result in noticeable latency that is disconcerting for the users and degrades overall impressions with respect to quality of service. For this reason, it ordinarily would not be practical to assign arbitration tasks to the wireless communication devices 14. By transmitting the audio immediately with the access request, however, system 10 substantially reduces latency and permits implementation of arbitration features in the wireless communication devices 14 without adversely impacting quality of service. In this manner, system 10 also promotes greater flexibility of design, enabling use of wireless communication devices 14 for arbitration.

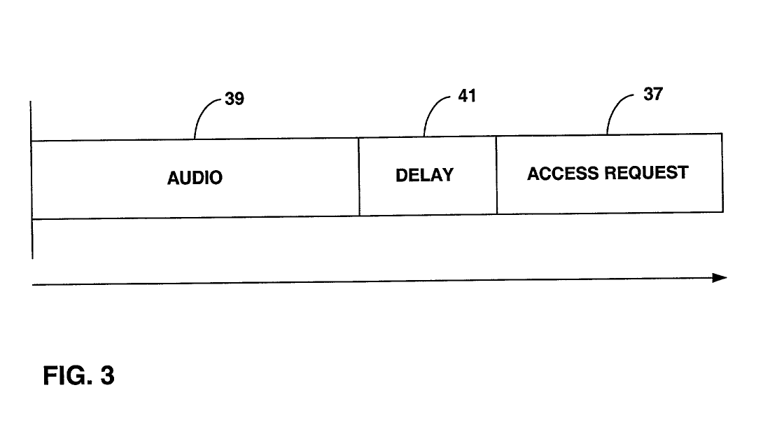

FIG. 3 is a timing diagram illustrating a process for arbitration of audio communication in a wireless communication system. As shown in FIG. 3, a wireless communication device 14 transmits an access request 37 to base station 12 when access to the broadcast link is desired. Access request 37 is accompanied by all or part of an audio communication 39 made by the user of the wireless communication device 14. Audio communication 39 may follow immediately after access request 37 or be separated by a slight time delay 41. As will be described, in some embodiments, the audio communication itself may serve as the access request, i.e., be interpreted by the arbitration controller as an access request. In either case, wireless communication device 14 transmits the audio communication without waiting for an acknowledgement that the access request has been granted.

Although FIG. 3 depicts access request 37 and audio communication 39 as being transmitted together, they may be transmitted over separate channels or links. For example, access request 37 may be transmitted using a control channel, a paging channel, a traffic channel, or the like, whereas audio may be transmitted over an audio channel established between a wireless communication device 14 and base station 12. If the audio also functions as the access request, then the access request can be made via the audio channel. Thus, base station 12, may receive communications from individual wireless communication devices 14 over both control channels and audio channels, and route audio communications onto a broadcast link for receipt by all wireless communication devices in a group.

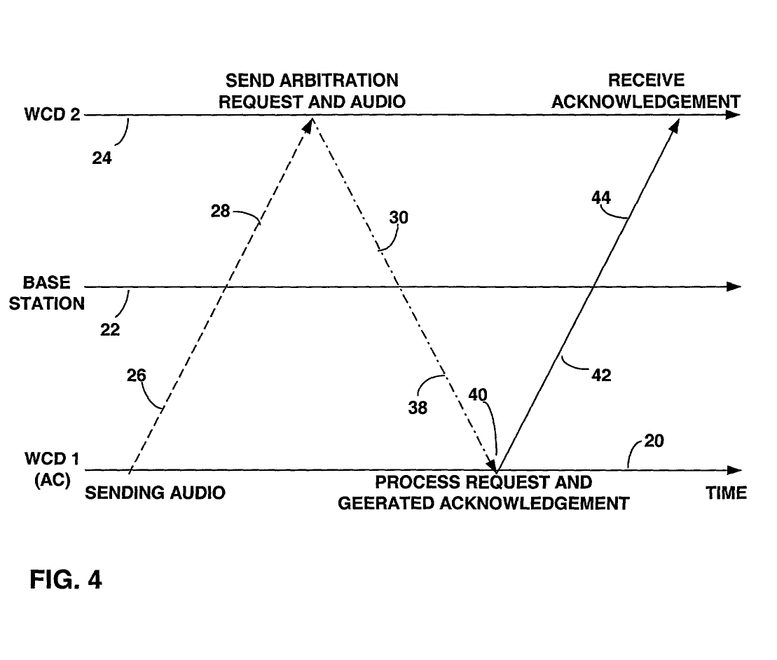

FIG. 4 is a diagram illustrating an arbitration path according to another embodiment of a wireless communication system 10. In the example of FIG. 4, it is assumed that arbitration is performed by a wireless communication device 14 rather than base station 12. Thus, FIG. 4 illustrates the scenario in which a wireless communication device 14 requesting access to the broadcast link could suffer a two round-trip delay. In system 10, however, the audio communication is transmitted by wireless communication device 14 immediately with the request for access, reducing the delay and resultant latency.

In this scenario, it is assumed that arbitration responsibility falls upon the wireless communication device presently holding priority over the broadcast link. As shown in FIG. 4, WCD 1 initially holds priority over the broadcast link, and hence is at least temporarily responsible for arbitration of access requests made by other wireless communication devices. Initially, WCD 1 is transmitting audio (26). The network equipment, e.g., base station 12, receives the transmitted audio and redistributes it over the broadcast link for receipt by other wireless communication devices, including WCD 2 (28).

Assuming WCD 2 requests access to the broadcast link, the request is sent to the network equipment (30), and then is sent by the network equipment over the broadcast link to WCD 1 for arbitration (38). WCD 2 immediately transmits the audio communication with the access request, whether it is sent over the same channel or not. The audio communication may be buffered by WCD 2 pending the result of arbitration. WCD 1 arbitrates the request versus any other requests made by other wireless communication devices 14 (40) and transmits an acknowledgement indicating whether the request was granted or denied (42). Upon completion of arbitration in favor of WCD 2, WCD 1 also may signal to the network equipment that the broadcast link should be allocated to WCD 2. In this case, the audio sent with the access request is immediately transmitted over the broadcast link by the network equipment. In addition, the network equipment transmits the acknowledgment to WCD 2 (44), which may provide an indication of the acknowledgment to the user.

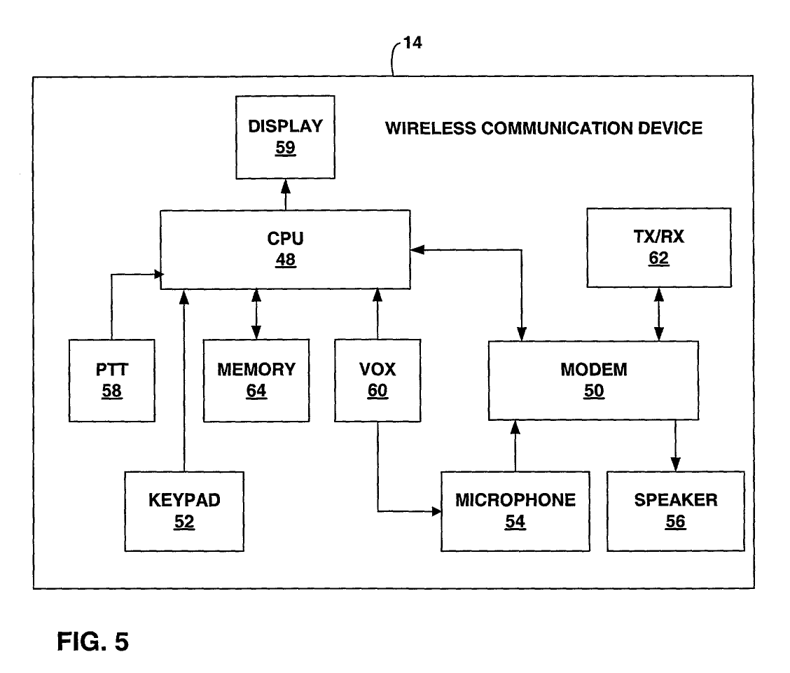

FIG. 5 is a block diagram illustrating the general structure of an example wireless communication device 14 for use in system 10. As shown in FIG. 5, wireless communication device 14 may include a CPU 48 and modem 50. CPU 48 controls modem 50 to transmit and receive communications via a transmitter/receiver circuit 62. CPU 48 executes instructions stored in memory 64. CPU 48 also may process user input via keypad 52 and a push-to-talk (PTT) button 58. In particular, a user depresses PTT button 58 when access to the broadcast link is desired. PTT button 58 may be a physical button or a virtual button presented via a user interface, e.g., display 59. In either case, the user uses PTT button 58 to initiate access to the broadcast link and, in accordance with some embodiments, may commence speaking immediately following actuation of PTT button 58 instead of waiting for acknowledgement that the access request has been granted.

As an alternative to PTT button 58, wireless communication device 14 also may include a voice-operated switch (VOX) 60 that is responsive to speech entered by the user via by speaking a microphone 54. Use of either PTT button 58 or VOX 60 may be selected by the user depending on individual choice or environments conditions. For example, PTT button 58 may be a more reliable choice when the user is in a noisy area. In other areas, the user may find VOX 60 to be more convenient. Microphone 54 may be integrated with a handset associated with wireless communication device 14 or take the form of an external microphone. Modem 50 receives the audio input from microphone 54 and modulates the audio into a format appropriate for transmission via transmitter/receiver 62. Modem 50 also drives a speaker 56 to emit audio output representing communications sent by other wireless communication devices 14 via the broadcast link.

When the user actuates PTT button 58 or VOX 60 is triggered by speech input from microphone 54, CPU 48 drives modem 50 to generate both an access request and an audio communication representative of the speech input. Modem 50 then transmits the access request and the audio communication via transmitter/receiver 62. Upon receipt of an unfavorable acknowledgement, i.e., the access request is denied, from base station 12, modem 50 terminates the audio transmission. In this case, CPU 48 may provide an indication that the access request is denied via speaker 56, display 59, or a vibration device (not shown). If the acknowledgement is favorable, however, modem 50 continues to transmit the audio spoken into microphone 54 by the user. If wireless communication device 14 is also responsible for arbitration, CPU 48 may serve as a processor programmed to carry out a desired arbitration process as described herein. In addition, memory 64 may store information, such as priority assignments, useful in conducting the arbitration process.

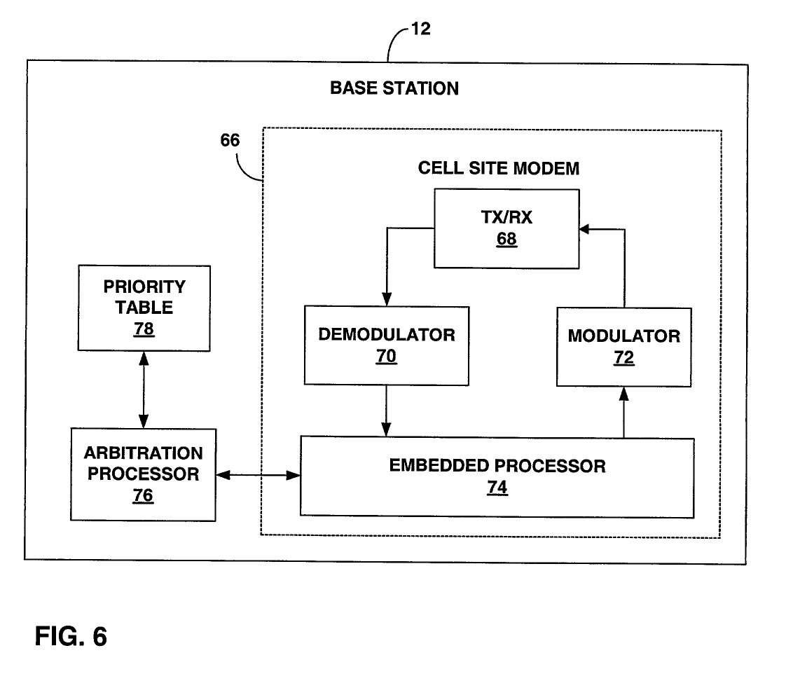

FIG. 6 is a block diagram illustrating the general structure of an example base station 12 for use in the system of FIG. 1. As shown in FIG. 6, base station 12, may include a cell site modem 66 that drives transmission and reception of communication among groups of wireless communication devices 14. Cell site modem may include a transmitter/receiver circuit 69, a demodulator 70 and modulator 72, and an embedded processor 74 that controls the modulator and demodulator.

For purposes of example, FIG. 6 also depicts an arbitration processor 76 that consults a priority table 78 in arbitrating requests from different wireless communication devices 14 to access to the broadcast link. Priority table 76 may assign arbitration priorities to individual wireless communication devices 14 made party to a particular call. Based on the assigned priorities, arbitration processor 76 determines whether to grant or deny requests for access by different wireless communication devices. Of course, a wide variety of different arbitration schemes, including those that do not require assignment of priority, may be used to conduct arbitration. In addition, arbitration processor 76 may be implemented in a variety of alternative network equipment that interact with base station 12.

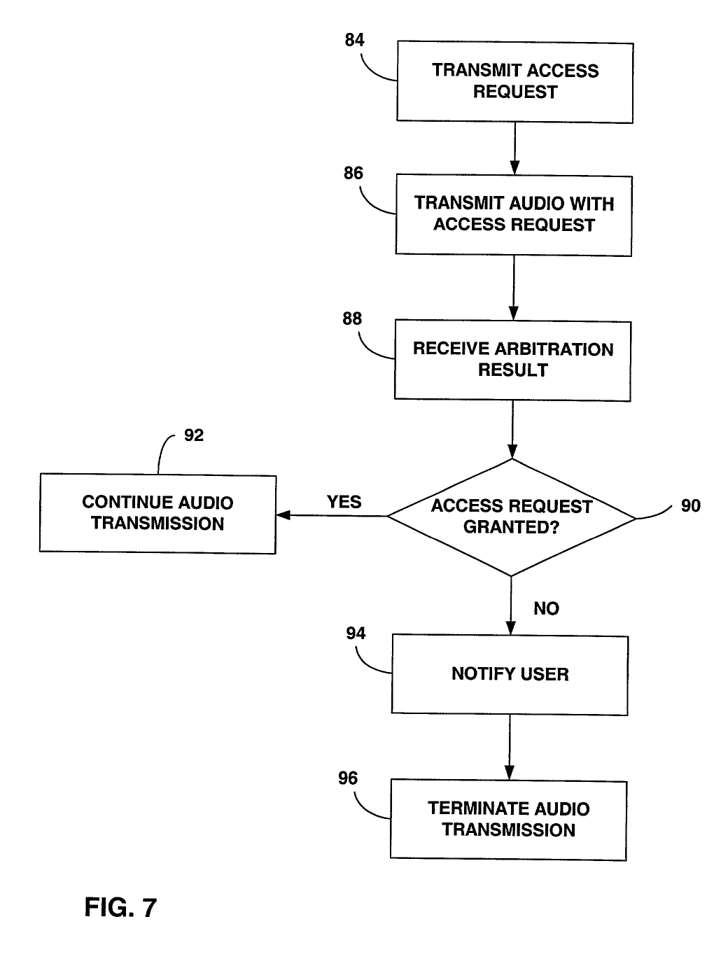

FIG. 7 is a flow diagram illustrating a process for arbitration of audio communication in wireless communication system 10. In particular, FIG. 7 outlines an exemplary process from the perspective of a wireless communication device 14 seeking access to the broadcast link. As shown in FIG. 7, the wireless communication device 14 transmits an access request (84) and transmits desired audio with the access request (86). As mentioned above, the audio may be transmitted on a separate channel from the access request, but is transmitted substantially immediately following transmission of the access request. In some embodiments, the access request and the transmitted audio may be one and the same.

Upon receipt of the arbitration result (88), from base station 12 or another wireless communication device via the network equipment, the requesting wireless communication device determines whether the access request was granted (90). If so, wireless communication device 14 continues the audio transmission (92) and the user may continue to speak. If not, wireless communication device 14 generates a notification for the user indicating that the access request has been denied (94). In this case, wireless communication device 14 terminates the audio transmission (96).

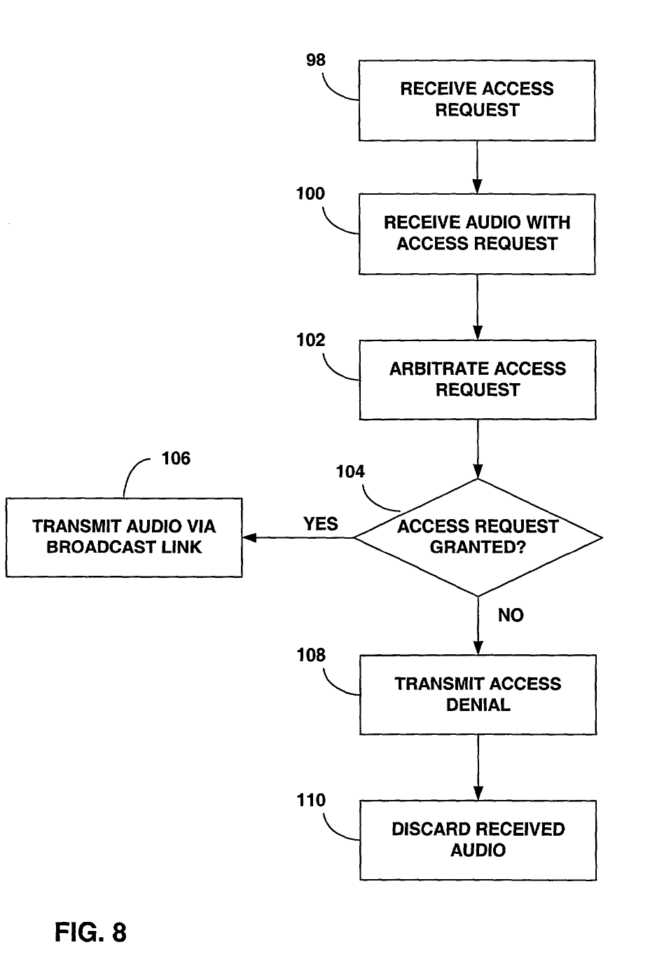

FIG. 8 is a flow diagram illustrating a process for arbitration of audio communication in wireless communication system 10 from the perspective of base station 12. As shown in FIG. 8, base station 12 receives an access request from a wireless communication device 14 (98), and receives audio with the access request (100). Base station 12, or other wireless network equipment, then arbitrates the request and determines whether to grant access to the broadcast link to the wireless communication device requesting access (102). Base station 12 or other wireless network equipment may temporarily buffer the received audio while the arbitration is conducted. If the access request is granted (104), base station 12 transmits the received audio over the broadcast link for receipt by other users (106), and keeps the broadcast link open for continued audio communication by the requesting device. If the access request is denied, base station 12 transmits an indication to that effect (108), and discards the received audio (110).

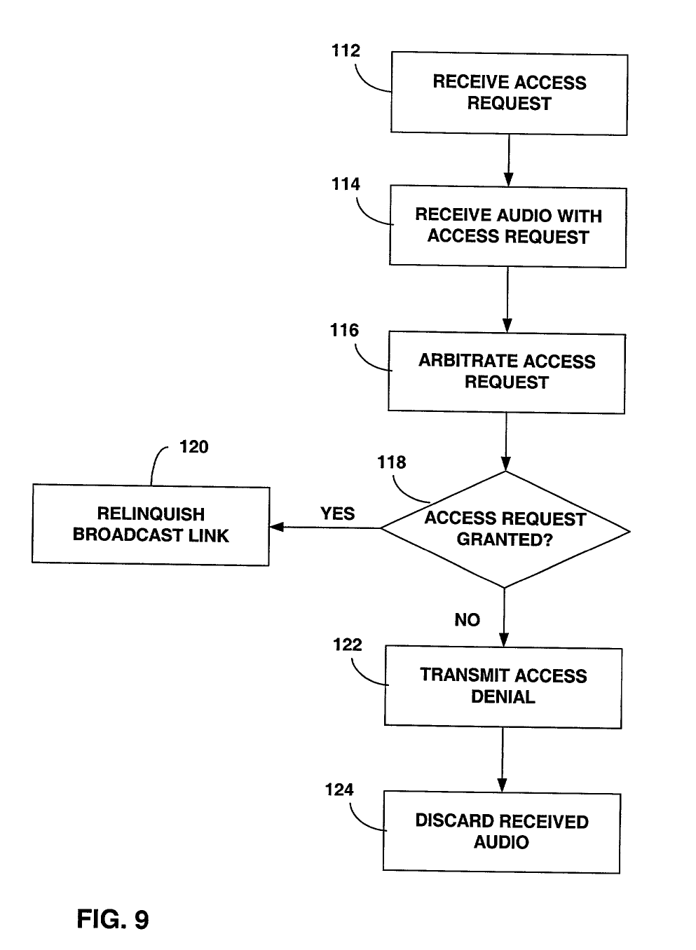

FIG. 9 is a flow diagram illustrating a process for arbitration of audio communication in wireless communication system 10 from the perspective of a wireless communication device 14 responsible for arbitration. As shown in FIG. 9, wireless communication device 14 receives an access request from another wireless communication device (112), and also receives audio with the access request (114). The arbitrating device may presently have access to the broadcast link, and therefore is responsible for arbitration. The arbitrating device 14 arbitrates the request and determines whether to grant access to the broadcast link to the wireless communication device requesting access (116). In some embodiments, arbitration will involve arbitration among multiple devices that may be requesting access as well as the device that presently has access. If the access request is granted (118), the arbitrating device relinquishes control of the broadcast link to the requesting device (120), and may transmit a communication to base station 12 to that effect. If the access request is denied, the arbitrating device 14 transmits an indication to the requesting device to that effect (122), and instructs base station 12 to discard the received audio (110).

As described above, to reduce latency, audio can be transmitted immediately upon transmission of an access request. In addition, the audio transmission may be interpreted as the access request. The audio used to form the access request need not be audible to other users who use the wireless communication devices, but may be detectable by the wireless communication devices associated with the users. Also, the audio may be generated by a user or automatically by a wireless communication device, e.g., in response to depression of a button on the device.

Ordinarily, audio generated by a user may be muted to avoid transmission to other devices. While transmitted audio is muted, a user may transmit information such as background noise estimates and other information helpful in maintaining the connection among all of the wireless communication devices. When access is requested, however, audio generated by the user is transmitted to the other devices. In this manner, when transmitted audio is detected, a wireless communication device interprets the audio as an indication that another user has requested access to the broadcast link.

Detection may be optimized to allow for imperfections in the transmitted audio such as clicks, pops, and errors in wireless transmission without triggering arbitration. For example, hysteresis could be used to require that an audio transmission must persist for a minimum length of time to be interpreted as an access request. After transmitting audio as an access request, the requesting user may be subjected to a short delay to allow other users times to stop transmitting audio before the access request is processed. This interval may be greater than a one-half round trip delay in a system where the audio transmission is arbitrated in a base station controller, and greater than one round trip delay where the audio transmission is arbitrated within the wireless communication devices.

Also, system 10 may be a “hybrid” in the sense that it accommodates communication devices configured for arbitration as described herein and more conventional communication devices. For example, system 10 may be arranged to permit communication between wireless communication devices that wait for a positive acknowledgement of access before sending audio and wireless communication devices that send audio immediately with an access request as described herein. Also, system 10 may permit “hybrid” arbitration by accommodating arbitration controllers that arbitrate access requests based on messaging containing a request or audio that is interpreted as a request.

The audio transmission that serves as the access request may be accompanied by additional information, such as information about the user requesting access. The information may include the name, phone number, or both, for the user. When the information is transmitted to other users, it may be displayed by display devices, e.g., an LCD display, associated with the wireless communication devices to indicate which user is requesting access to the broadcast link. The access request sent to the other users may be modified prior to being sent to the other callers, such that it indicates more or less information about the requester. This type of feature may be especially useful when some of the users are not using wireless communication devices that readily support transmission of the user information, or when the access request is augmented by a base station controller to include additional information. The user information also could be sent after arbitration of the access request, or as an indication that arbitration is desired, such as when using a prioritized arbitration technique.

Instructions for causing a processor provided in a wireless communication device or network equipment to carry out the arbitration techniques described herein may be stored on computer-readable media. For example, the media may comprise storage media and/or communication media. Storage media may include volatile and nonvolatile, removable and fixed media implemented in any method or technology for storage of information such as processor-readable instructions, data structures, program modules, or other data. Storage media may include, but is not limited to, random access memory (RAM), read-only memory (ROM), EEPROM, flash memory, fixed or removable disc media, including optical or magnetic media, or any other medium that can be used to store the desired information and that can be accessed by a processor within WCD 10.

Communication media typically embodies processor readable instructions, data structures, program modules, or other data in a modulated data signal, such as a carrier wave or other transport medium and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Computer readable media may also include combinations of any of the media described above.

Various embodiments have been described. These and other embodiments are within the scope of the following claims.

1. A method comprising:
transmitting a request for access to a broadcast link in a point-to-multipoint communication system;
transmitting audio with the access request; and
terminating the audio transmission in the event the access request is denied.

2. The method of claim 1, wherein transmitting audio includes transmitting the audio immediately following transmission of the access request.

3. The method of claim 1, wherein transmitting audio includes transmitting the audio before receiving an acknowledgement that the access request is granted.

4. The method of claim 1, wherein transmitting audio includes transmitting the audio without receiving an acknowledgement that the access request is granted.

5. The method of claim 1, wherein at least a portion of the audio transmission serves as the access request.

6. The method of claim 1, further comprising receiving an acknowledgement that the access request is granted during transmission of the audio.

7. The method of claim 1, further comprising receiving the denial of the access request from an arbitration controller.

8. The method of claim 1, further comprising transmitting the audio to the broadcast link via wireless network equipment.

9. The method of claim 1, further comprising receiving the denial of the access request from a wireless communication device in the system via a wireless base station.

10. The method of claim 1, further comprising generating the denial of the access request within a wireless communication device that presently has access to the broadcast link.

11. The method of claim 1, further comprising transmitting the access request in response to actuation of a push-to-talk input medium associated with a wireless communication device.

12. A method comprising:.
receiving a request for access to a broadcast link in a point-to-multipoint communication system;
receiving audio with the access request; and
transmitting the audio via the broadcast link in the event the access request is granted.

13. The method of claim 12, further comprising discarding the audio in the event the access request is denied.

14. The method of claim 12, wherein receiving audio includes receiving the audio immediately following transmission of the access request.

15. The method of claim 12, further comprising transmitting an indication that the access request is granted after receiving the audio.

16. The method of claim 12, further comprising transmitting an indication that the access request is denied after receiving the audio.

17. The method of claim 12, further comprising interpreting at least a portion of the audio transmission as the access request.

18. The method of claim 12, further comprising:
transmitting the access request to a wireless communication device in the system; and
receiving an indication that the access request is denied from the wireless communication device.

19. The method of claim 18, wherein transmitting the access request includes transmitting the access request to a wireless communication device that presently has access to the broadcast link.

20. A wireless communication device comprising:
a wireless transmitter; and
a processor that controls the transmitter to transmit a request for access to a broadcast link in a point-to-multipoint communication system, transmit audio with the access request, and terminate the audio transmission in the event the access request is denied.

21. The device of claim 20, wherein the processor controls the transmitter to transmit the audio immediately following transmission of the access request.

22. The device of claim 20, wherein the processor controls the transmitter to transmit the audio before receiving an acknowledgement that the access request is granted.

23. The device of claim 20, wherein the processor controls the transmitter to transmit the audio without receiving an acknowledgement that the access request is granted.

24. The device of claim 20, wherein at least a portion of the audio transmission serves as the access request.

25. The device of claim 20, wherein the transmitter transmits the audio to the broadcast link via wireless network equipment.

26. An arbitration controller for a point-to-multipoint communication system, the arbitration controller comprising a processor that receives a request for access to a broadcast link from a wireless communication device in a point-to-multipoint communication system, wherein the wireless communication device transmits audio with the request for access, the processor determining whether to grant the access request, and directing transmission of the audio via the broadcast link in the event the access request is granted.

27. The device of claim 26, wherein the processor directs discarding of the audio in the event the access request is denied.

28. The device of claim 26, wherein the processor directs transmission of an indication that the access request is granted or denied.

29. The device of claim 26, wherein the transmitter transmits an indication that the access request is granted or denied.

30. The device of claim 26, wherein the processor interprets at least a portion of the audio transmission as the access request.

31. The device of claim 26, wherein the processor resides within a wireless communication device in the point-to-multipoint communication system.

32. The device of claim 26, wherein the processor resides within a network server in a wide area network associated with network equipment in the point-to-multipoint communication system.

33. A computer-readable medium carrying instructions that cause a processor in a wireless communication device in a point-to-multipoint communication system to:
transmit a request for access to a broadcast link in a point-to-multipoint communication system;
transmit audio with the access request; and
terminate the audio transmission in the event the access request is denied.

34. A computer-readable medium carrying instructions that cause a processor in network equipment in a point-to-multipoint communication system to:
receive a request for access to a broadcast link in the point-to-multipoint communication system;
receive audio with the access request; and
direct transmission of the audio via the broadcast link in the event the access request is granted.
